(19) United States
(12) Patent Application Publication
(10) Pub. No.: US 2008/0027741 A1
(43) Pub. Date: Jan. 31, 2008

(54) METHOD OF MANAGING LAUNDRY ROOM MACHINE AND SYSTEM THEREFOR

(75) Inventors: In-Hee Han, Changwon-shi (KR); Kang-Mo Choi, Masan-shi (KR); Ji-An Jeong, Changwon-shi (KR); Nam-Yeong Heo, Changwon-shi (KR)

Correspondence Address: KED & ASSOCIATES, LLP, P.O. Box 221200, Chantilly, VA, 20153-1200, US

(73) Assignee: LG Electronics Inc.

(21) Appl. No.: 11/753,018

(22) Filed: May 24, 2007

(30) Foreign Application Priority Data
May 26, 2006 (KR) 10-2006-0047733

(51) Int. Cl. G06Q 50/00

(52) U.S. Cl. 705/1

(57) ABSTRACT

The present invention discloses a method of managing laundry room machines in a laundry room. The method includes the step of: a) receiving identification information including an ID (identifier) through a communicator; b) setting information about the rate and operating conditions through the communicator; c) receiving a selection of a course allowed by an inserted payment after receiving information about insertion of the payment from the payment device; d) performing a predetermined operation according to the selected course; and e) recording operating information of the predetermined operation performed in the step d).

### TECHNICAL FIELD

The present invention relates to a method of managing laundry room machines in a laundry room, and more particularly, to a method of managing commercial laundry room machines, for example, a washer and a dryer, having a payment device such as a coin drop assembly or a card reader, and a system therefor.

### BACKGROUND ART

Generally, a commercial laundry room machine means a laundry room machine in a laundry room for providing self-laundry service, which has a payment device such as a coin drop assembly and a card reader. Such a commercial laundry room machine may be a coin-operated washer, a coin-operated dryer, or an all-in-one coin-operated washer and dryer. A laundry room includes a plurality of laundry room machines.

Accordingly, it is required to manage the laundry room and the laundry room machines. In order to effectively and efficiently manage a plurality of the laundry room machines and the laundry room, it is required not only to manage the operating information of the laundry room machines but also to control operators. Also, the laundry room machines must be protected from malicious attacks by customers. For example, the laundry room machines must be protected from being used for free or the operating conditions of the laundry room machine must be prevented from being changed by customers. In order to protect and prevent the laundry room machine from such malicious attacks, the laundry room machine must support a predetermined protection in physical and software manner.

Unlike home laundry machines, it is required to set the rate and washing and drying courses and to define a policy for handling the remaining payment after the operation of the commercial laundry room machine. Since the commercial laundry room machine includes a payment device, it is also required to manage the operation of the payment device as well as the laundry room machine.

### DISCLOSURE OF THE INVENTION

The present invention is achieved to solve the above problems. An object of the present invention is to provide a laundry room machine management method for effectively and efficiently managing laundry room machines disposed in a laundry room.

Another object of the present invention is to provide a laundry room machine management method for protecting laundry room machines from malicious attacks by a user.

Yet another object of the present invention is to provide a laundry room machine management method of managing laundry room machines for separately managing laundry room machines by assigning identification information to laundry room machines through a communicator and for stably managing the laundry room machines without confusion by preventing the assigned identification information from being modified.

Yet another object of the present invention is to provide a laundry room machine management method for effectively and efficiently managing the laundry room machines without additional high expense and additional equipment by separately managing the laundry room machines in software manner using a communicator such as a personal digital assistant (PDA), which intermediates communication between a plurality of laundry room machine and a personal computer (PC).

Yet another object of the present invention is to provide a laundry room machine management method for setting laundry room machines without influencing the operation of the laundry room machines.

Yet another object of the present invention is to provide a laundry room machine management method for smoothly operating laundry room machines by clearly defining a policy for handling a remaining payment.

Yet another object of the present invention is to provide a laundry room machine management method for clearly detecting a cause of malfunction by determining whether or not a payment device is out of order when laundry room machine malfunctions so as to effectively and efficiently manage the laundry room machines.

In order to achieve the above-described objects of the invention, there is provided a method of managing laundry room machines where each of the laundry room machines performs at least one of a washing operation and a drying operation and includes a payment device for collecting a payment for operating the laundry room machine, and an interface for communicating with a communicator for performing, the method including the step of: a) receiving identification information including an ID (identifier) through the communicator; b) setting information about the rate and operating conditions through the communicator; c) receiving a selection of a course allowed by an inserted payment after receiving information about insertion of the payment from the payment device; d) performing a predetermined operation according to the selected course; and e) recording operating information of the predetermined operation performed in the step d).

If it is requested to change the information set at the step b) while the laundry room machine is operating, data for changing may be temporally stored, and the set information is changed according to the stored information after the operation of the laundry room machine ends.

Breakdown of the payment device may be determined by exchanging a predetermined signal with the payment device at a regular interval.

In case of a disable mode, a remaining payment may be deleted after the operation of the laundry room machine ends, and in case of an enable mode, a remaining payment may be displayed to be usable after the operation of the laundry room machine ends.

In another aspect of the present invention, there is provided a commercial laundry room machine including: a first interface for communicating with a payment device disposed at each laundry room machine to transfer payment collecting information and exchanging a signal with the payment device at a predetermined interval; and a controller for controlling operation of a laundry room machine according to communication information of an interface and noticing breakdown information to a user when no signal is received for a predetermined time interval.

The breakdown information may be visually and auditorily informed to a user. The commercial laundry room machine may further include a second interface for communicating with a communicator to transfer at least one of identification information having an ID (identifier) of each laundry room machine, payment information, and operating information. The laundry room machine may be a washer or a dryer.

In yet another aspect of the present invention, there is provided a commercial laundry room machine including: a first interface for communicating with a payment device disposed corresponding to each laundry room machine to transfer payment collecting information and exchanging a signal with the payment device at a predetermined interval; and a controller for controlling operation of a laundry room machine according to communication information of an interface and handling money inserted more than a corresponding course rate according to a predetermined policy.

The commercial laundry room machine may further include a second interface for communicating with a communicator to transfer at least one of identification information having an ID (identifier) of each laundry room machine, payment information, and operating information. The policy for handling money inserted more than a corresponding course rate may be set to the controller through a communicator and the second interface. The laundry room machine may be a washer or a dryer.

### BRIEF DESCRIPTION OF THE DRAWINGS

The present invention will become better understood with reference to the accompanying drawings which are given only by way of illustration and thus are not limitative of the present invention, wherein:

FIG. 1 is a diagram illustrating a system for managing a laundry room according to an embodiment of the present invention;

FIG. 2 is a diagram illustrating laundry room machines according to an embodiment of the present invention;

FIG. 3 is a flowchart illustrating a method of setting operation conditions according to an embodiment of the present invention;

FIG. 4 is a flowchart illustrating a method of operating laundry room machine according to an embodiment of the present invention;

FIG. 5 is a flowchart illustrating a method of handling a remaining payment according to an embodiment of the present invention; and

FIG. 6 is a flowchart illustrating a method of determining whether a payment device beaks down or not according to an embodiment of the present invention.

### BEST MODE FOR CARRYING OUT THE INVENTION

A method of managing a laundry room machine in accordance with preferred embodiments of the present invention will now be described in detail with reference to the accompanying drawings.

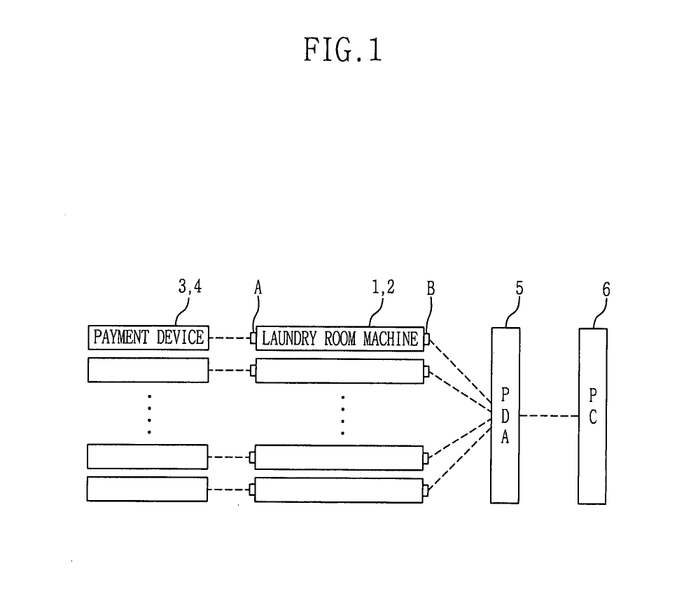

FIG. 1 is a diagram illustrating a system for managing laundry room machines according to an embodiment of the present invention.

As illustrated in FIG. 1, the laundry room management system according to the present embodiment include laundry room machines 1 and 2, payment devices 3 and 4, a communicator 5, and a computer 6. The laundry room machines 1 and 2 are equipped in a laundry room. The laundry room machines 1 and 2 perform at least one of a washing operation and a drying operation. Laundry room machines 1 and 2 include the payment devices 3 and 4 for collecting a payment for operating the laundry room machines 1 and 2. Also, the computer 6 such as a personal computer (PC) manages operating information of the laundry room machines 1 and 2. The communicator 5 such as a personal digital assistant (PDA) assigns identification information to the laundry room machines 1 and 2, sets the rate and operating conditions, and intermediates operating information between the computer 6 and the laundry room machine 1 and 2. The laundry room machines 1 and 2 include interfaces A and B for communicating with the payment devices 3 and 4 and with the communicator 5.

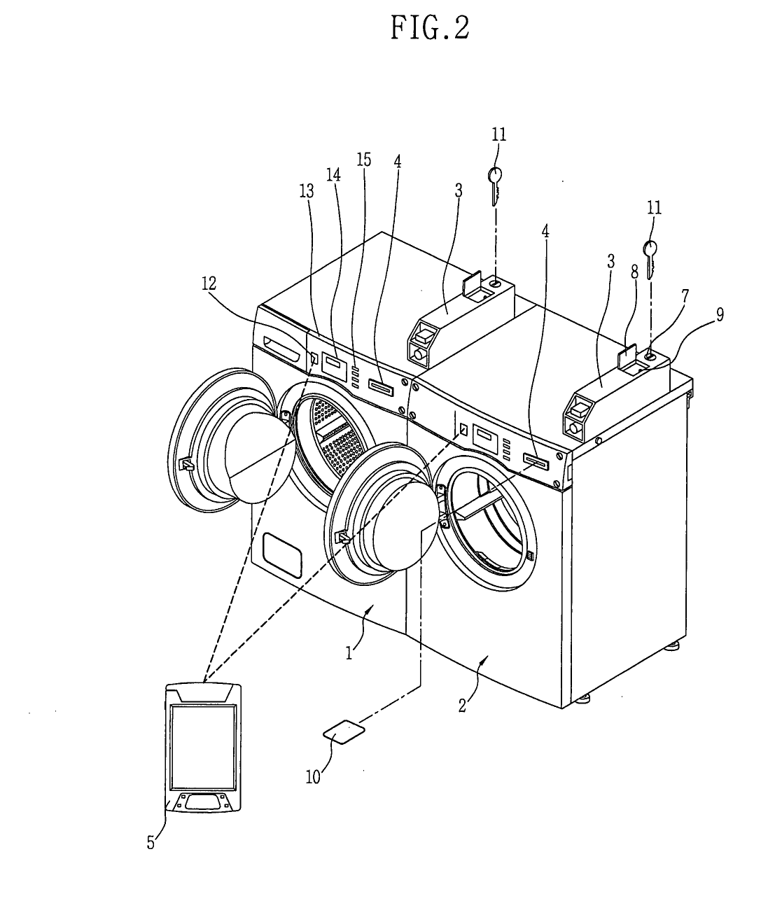

FIG. 2 is a diagram illustrating laundry room machines according to an embodiment of the present invention.

In FIG. 2, the laundry room machine 1 denotes a washer, and the laundry room machine 2 denotes a dryer. Each of the laundry room machines 1 and 2 includes a coin drop assembly 3 mounted on a top thereof and a card reader 4 disposed at a control panel 13 prepared on an upper side thereof as the payment device. A user is allowed to use the laundry room machines 1 and 2 by inserting coins or a debit card into the payment devices 3 and 4. A manager is enabled to set information about the rate and operating conditions by inserting a master key 10 or 11 such as a service card 10 or a service door key 11 into the payment devices 3 and 4. The coin drop assembly 3 includes a key hole 7 for receiving a service door key 11, and a sensor 9 for determining whether a service door key 11 is inserted or not through sensing the service door key 11. A sensor may be disposed directly at the key hole 7 in order to sense the service door key 11. The payment devices 3 and 4 are connected to the control panel 13 through a cable (not shown) so as to communicate with the laundry room machines 1 and 2. The communicator 5 communicates with the laundry room machines 1 and 2 through the interfaces 12, the interface B in FIG. 1, in a short range Infrared data communication scheme. The control panel 13 includes a display unit 14 and control buttons 15. The control panel 13 displays the amount of money inserted into the laundry room machine, displays conditions for operating the laundry room machine, and enables a user or a manager to set or to select operating conditions or a course.

Hereinafter, each of the constituent elements of the laundry room management system according to an embodiment of the present invention will be described.

1. Laundry Room Machines 1 and 2

Each of the laundry room machines 1 and 2 is a washer or a dryer. Also, each of the laundry room machines 1 and 2 may be an all-in-one washer and dryer. A plurality of laundry room machines are equipped in a laundry room for performing a washing operation, a drying operation, or a washing and drying operation.

In order to manage the laundry room machines 1 and 2, identification information having an identifier (ID) is assigned to the laundry room machines 1 and 2. The identification information may include serial numbers and location information of the laundry room machines 1 and 2. Since the identification information is assigned to the laundry room machines as described above, the laundry room machines can be separately managed.

It is preferable to allow only the communicator 5 to assign the identification information. Further preferably, the identification information is assigned only before inputting the identification information into the laundry room machines 1 and 2 in order to prevent the assigned identification information from being modified. That is, the identification information is modified only when the laundry room machine is reset to have a state of no identification information inputted like a newly manufactured laundry room machine. Since the identification information is prevented from being modified, the laundry room machine 1 and 2 can be stably managed without confusion.

In order to operate the laundry room machines 1 and 2, the rate and operating conditions must be set. The rate and the operating conditions can be set by the communication with the communicator 5 or by the operation of the control panel 13 with the master key 10 or 11 inserted according to the present embodiment. Due to such a method of setting up the rate and the operating conditions according to the present embodiment, only a manager who has the communicator 5 or the master key 10 or 11 is allowed to set the rate and the operating conditions. Therefore, the laundry room management system according to the present embodiment can prevent users from modifying the rate and the operating conditions of the laundry room machines.

After a user inserts coins or a card to the payment devices 3 or 4 and sets the operating conditions through the control panel 13, the laundry room machines 1 and 2 performs predetermined operations according to the set operating conditions and records operating information thereof.

Then, the laundry room machines 1 and 2 transmit the recorded operating information to the communicator 5 in response to a request from the communicator 5.

2. Payment Devices 3 and 4

The payment devices 3 and 4 are a coin drop assembly 3 and a card reader 4. Each of the laundry room machines 1 and 2 includes one of the coin drop assembly 3 and the card reader 4 or both of the coin drop assembly 3 and the card reader 4.

The payment devices 3 and 4 check whether or not a coin or a card is inserted. If payment devices 3 and 4 detect insertion of the coin or the card, the payment devices 3 and 4 inform the laundry room machines 1 and 2 of the insertion. When the mater keys 10 and 11 are inserted, the payment devices 3 and 4 also notice the insertion of the master keys to the laundry room machines 1 and 2. Then, the laundry room machine 1 and 2 changes a current mode to a setting mode.

3. Communicator 5

The communicator 5 is a device for communicating with the laundry room machines 1 and 2 and the computer 6. It is preferable to use a personal digital assistant (PDA) capable of communicating with the laundry room machines 1 and 2 as the communicator in a short range Infrared data communication scheme. A mobile phone may be used as the communicator if the capacity thereof allows.

The communicator 5 has a unique function of assigning identification information to the laundry room machines 1 and 2. The communicator 5 also has functions of setting the rate and operating conditions of the laundry room machines 1 and 2, collecting the recorded operating information of the laundry room machines 1 and 2, and transmitting the collected information to the computer 6. The collected operating information is transmitted to the computer for management. However, the collected operating information may be transmitted to the communicator 5 and displayed on the communicator 5 in order to easily confirm the operating information.

4. Computer 6

In case of managing a small sized laundry room, a personal computer (PC) is sufficient to use as the computer 6. In case of managing a plurality of laundry rooms, a computing system composed of a plurality of computers can be used.

The computer 6 manages the operating information of the laundry room machines 1 and 2, which are transferred from the communicator 5. Furthermore, the computer 6 can set the communicator 5 to manage managers having the communicator 5, for example, to assign authority. Based on such a setting, the communicator 5 may be set to perform all or one of an operation of assigning identification information, an operation of setting operating information, and an operation of collecting operating information.

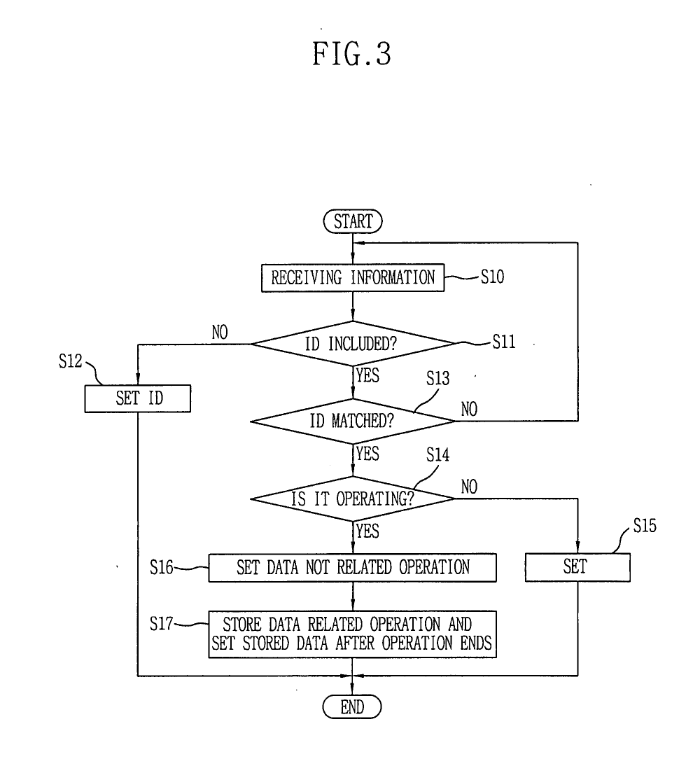

FIG. 3 is a flowchart illustrating a method of setting operation condition according to an embodiment of the present invention.

Referring to FIG. 3, the laundry room machines 1 and 2 receive identification information from the communicator 5 at step S10. Then, the laundry room machines 1 and 2 determine whether an ID is included in the received identification information or not at step S11. If the ID is not included, an operation of inputting identification information including an ID is performed at step S12. If the ID is included, the laundry room machines 1 and 2 determine whether the received ID is matched with previously stored IDs at step S13. If the ID is matched with the previously stored ID, it is determined whether the laundry room machines 1 and 2 are operating or not at step S14. If the laundry room machine is not operating, information about the rate and operating conditions are set immediately at step S15. If the laundry room machine is operating and if data for setting the laundry room machine will not influence the operation of the laundry room machines, the laundry room machine is set immediately at step S16. If the laundry room machine is operating and if data for setting the laundry room machine will influence the operation of the laundry room machine, the data is stored. Then, the laundry room machine is set with the stored data at step S17 after the operation of the laundry room machine ends. In FIG. 3, the identification information is inputted or the operating conditions are set according to whether the ID is included in the received information or not. However, the described method is only a preferred exemplary embodiment of the present invention. When the communicator 5 transfers the information, the communicator 5 may inform the laundry room machines 1 and 2 of a setting related to the transferred information.

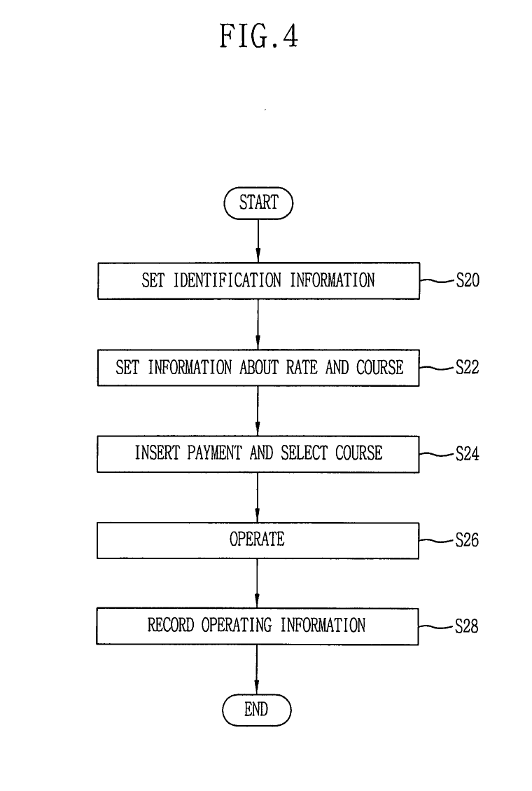

FIG. 4 is a flowchart illustrating a method of operating laundry room machines according to an embodiment of the present invention.

Referring to FIG. 4, the identification information of the laundry room machine 1 and 2 is set through the communicator 5 at step S20. Then, the rate and operation courses of the laundry room machine 1 and 2 are set through the communicator 5 at step S22. After receiving information about insertion of a coin or a card from the payment devices 3 and 4, the received information is displayed on the display unit 14 and the operation courses are selected through the control buttons 15 at step S24. Then, the laundry room machines are operated according to the selected operation courses at step S26, and the operating information of the laundry room machines is recorded at step S28. Since the communicator 5 is used to set the laundry room machines 1 and 2 as described above, the laundry room machines 1 and 2 can be easily set regardless of the operation of the laundry room machines. Furthermore, the step of setting the laundry room machine with the stored data is provided in the present embodiment. That is, an operation of setting a laundry room machine can be independently performed although the laundry room machine is operating. Therefore, a manager can set the laundry room machines 1 and 2 whenever the manager wants.

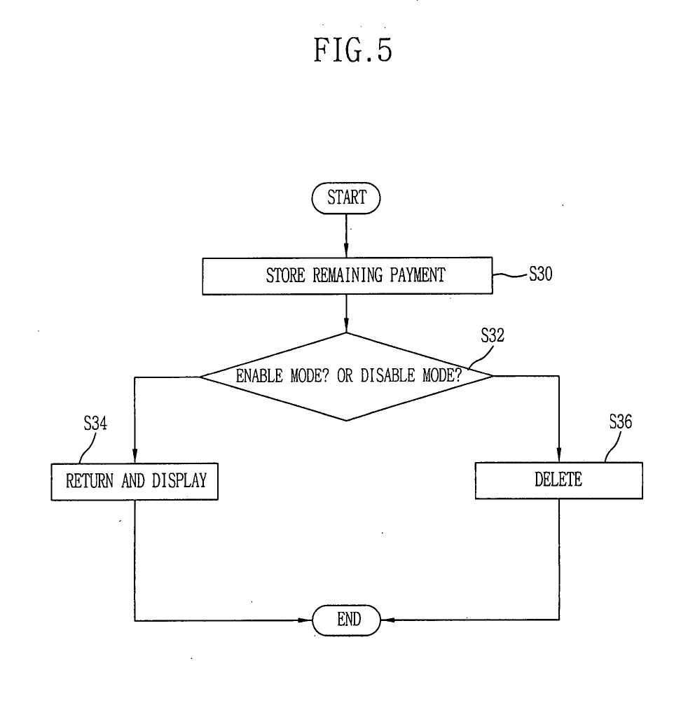

FIG. 5 is a flowchart illustrating a method of handling a remaining payment according to an embodiment of the present invention.

Occasionally, customers may insert more money than the rate requested for a selected operation course into the payment device 3 or 4. Accordingly, it is required to define a policy for handling the remaining payment and to provide selections of handling the remaining payment to customers according to the defined policy in order to smoothly manage the laundry room. Reference to FIG. 5, if a user inserts more money than the rate required for a selected operation course before operating the laundry room machine, or if a user inserts money while the laundry room machine is operating, the remaining payment is stored at step S30 and a policy used by a manager is determined at step S32. In case of an enable mode, the remaining payment is returned, immediately. That is, the remaining payment is displayed on the display unit 14 at step S34 in order to enable a user to use the remaining payment for the next operation of the laundry room machine. In case of a disable mode, the remaining the rate is deleted at step S36.

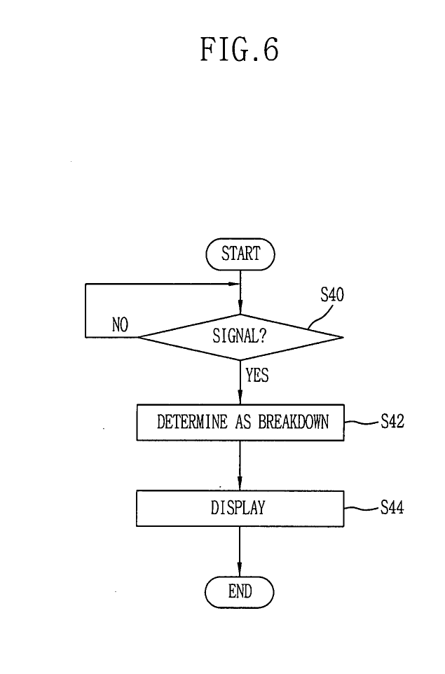

FIG. 6 is a flowchart illustrating a method of determining whether a payment device is out of order or not according to an embodiment of the present invention.

Referring to FIG. 6, in order to determine whether or not the payment device is out of order, the laundry room machine 1 and 2 exchange a predetermined signal with the payment devices 3 and 4 at a regular interval for example about 10 second at step S40. When the laundry room machines 1 and 2 do not receive the predetermined signal from the payment devices 3 and 4 for a predetermined time interval, the laundry room machines 1 and 2 determine that the payment devices 3 and 4 break down at step S42. Then, the laundry room machines 1 and 2 display information about the breakdown of the payment device on the display unit 14 or play a predetermined sound at step S44. When the laundry room machines 1 and 2 malfunction, the method of the present embodiment makes it easy to determine which one of the payment device and the laundry room machine causes the malfunction. Sine the laundry room machines 1 and 2 may be manufactured by a different manufacturer from that of the payment devices 3 and 4, and since different service men need to repair the laundry room machines 1 and 2 and the payment devices 3 and 4, the method of the present embodiment makes it convenient to manage the commercial laundry machines.

According to the certain embodiment of the present invention, laundry room machines in a laundry room can be effectively and efficiently managed.

Also, laundry room machines can be protected from malicious attacks by a user.

Furthermore, each of the laundry room machines can be independently managed by assigning identification information to laundry room machines through the communicator. The laundry room machines can be stably managed without confusion through preventing the assigned identification information from modifying.

Moreover, the laundry room machines can be effectively and efficiently managed without high cost and additional equipment by independently managing the laundry room machine in software manner using a communicator such as a personal digital assistant (PDA), which intermediates communication between a plurality of laundry room machine and a personal computer (PC).

In addition, each of the laundry room machines can be set without influencing the others.

In addition, the laundry room machines can be smoothly managed by defining a clear policy of handling a remaining payment.

In addition, when the laundry room machine malfunctions, the cause of the malfunction can be clearly detected by determining whether or not the payment device is out or order. Accordingly, corresponding repair services can be provided quickly, and a laundry room can be effectively and efficiently managed.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A method of managing laundry room machines where each of the laundry room machines performs at least one of a washing operation and a drying operation and includes a payment device for collecting a payment for operating the laundry room machine, and an interface for communicating with a communicator for performing, the method comprising the step of:
a) receiving identification information including an ID (identifier) through the communicator;
b) setting information about the rate and operating conditions through the communicator;
c) receiving a selection of a course allowed by an inserted payment after receiving information about insertion of the payment from the payment device;
d) performing a predetermined operation according to the selected course; and
e) recording operating information of the predetermined operation performed in the step d).

2. The method of claim 1, wherein if it is requested to change the information set at the step b) while the laundry room machine is operating, data for changing is temporally stored, and the set information is changed according to the stored information after the operation of the laundry room machine ends.

3. The method of claim 1, wherein breakdown of the payment device is determined by exchanging a predetermined signal with the payment device at a regular interval.

4. The method of claim 1, wherein in case of a disable mode, a remaining payment is deleted after the operation of the laundry room machine ends, and in case of an enable mode, a remaining payment is displayed to be usable after the operation of the laundry room machine ends.

5. A commercial laundry room machine comprising:
a first interface for communicating with a payment device disposed at each laundry room machine to transfer payment collecting information and exchanging a signal with the payment device at a predetermined interval; and
a controller for controlling operation of a laundry room machine according to communication information of an interface and noticing breakdown information to a user when no signal is received for a predetermined time interval.

6. The commercial laundry room machine of claim 5, wherein the breakdown information is visually and auditorily informed to a user.

7. The commercial laundry room machine of claim 5, further comprising a second interface for communicating with a communicator to transfer at least one of identification information having an ID (identifier) of each laundry room machine, payment information, and operating information.

8. The commercial laundry room machine of claim 5, wherein the laundry room machine is a washer or a dryer.

9. A commercial laundry room machine comprising:
a first interface for communicating with a payment device disposed corresponding to each laundry room machine to transfer payment collecting information and exchanging a signal with the payment device at a predetermined interval; and
a controller for controlling operation of a laundry room machine according to communication information of an interface and handling money inserted more than a corresponding course rate according to a predetermined policy.

10. The commercial laundry room machine of claim 9, further comprising a second interface for communicating with a communicator to transfer at least one of identification information having an ID (identifier) of each laundry room machine, payment information, and operating information.

11. The commercial laundry room machine of claim 10, wherein the policy for handling money inserted more than a corresponding course rate is set to the controller through a communicator and the second interface.

12. The commercial laundry room machine of claim 9, wherein the laundry room machine is a washer or a dryer.
